(19) United States
(12) Patent Application Publication
(10) Pub. No.: US 2012/0017116 A1
(43) Pub. Date: Jan. 19, 2012

(54) MEMORY CONTROL DEVICE, MEMORY DEVICE, AND MEMORY CONTROL METHOD

(75) Inventors: Motohiro Matsuyama, Hino-shi (JP); Hirotaka Suzuki, Oume-shi (JP); Kiyotaka Iwasaki, Kawasaki-shi (JP); Tohru Fukuda, NishiTokyo-shi (JP)

(73) Assignee: KABUSHIKI KAISHA TOSHIBA, Tokyo (JP)

(21) Appl. No.: 13/082,048

(22) Filed: Apr. 7, 2011

(30) Foreign Application Priority Data
Jul. 16, 2010 (JP) 2010-161919

(51) Int. Cl. G06F 11/14; G06F 11/07

(52) U.S. Cl. 714/17; 714/48; 714/E11.024; 714/E11.114

(57) ABSTRACT

According to one embodiment, a memory control device includes a first controller, a second controller, an access module, and a response sort module. The first controller controls processing of a data access command to a nonvolatile memory from a host. The second controller controls processing assigned to the second controller between the first controller and the second controller. The access module performs data access to the nonvolatile memory in response to a command from the first controller or the second controller. When an error occurs in the data access by the access module, the response sort module returns a response to the second controller instead of the first controller.

### CROSS-REFERENCE TO RELATED APPLICATIONS

This application is based upon and claims the benefit of priority from Japanese Patent Application No. 2010-161919, filed Jul. 16, 2010, the entire contents of which are incorporated herein by reference.

### FIELD

Embodiments described herein relate generally to a memory control device, a memory device, and a memory control method.

### BACKGROUND

There have been known solid state drives (SSDs) provided with a system-on-a-chip (SoC) comprising a first central processing unit (CPU) and a second CPU. The first CPU controls processing of a data access command to a NAND flash memory from a host. The second CPU controls processing assigned thereto between the first and the second CPUs. In response to a command from the first CPU, the SoC performs data access to the NAND flash memory.

In this type of SSD, internal errors are not distinguished between the front-end side and the back-end side and are lumped all together. When an error occurs, a response to report the error is sent to the first CPU that has issued a command. Then, the first and the second CPUs communicate with each other to recover the error. As a result, error recovery requires considerable time. Especially, since errors occur frequently due to the NAND flash memory on the back-end side. Considering the performance of the entire system, there is a need for efficient error recovery.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an example block diagram of a solid state drive (SSD) according to an embodiment;

FIG. 2 is an example detailed block diagram of a host interface circuit and a NAND flash memory controller illustrated in FIG. 1 in the embodiment;

FIG. 3 is an example flowchart of the operation of the SSD mainly on the back-end side in the embodiment;

FIG. 4 is an example sequence diagram of the operation of the SSD to process a user write command in the embodiment;

FIG. 5 is an example sequence diagram of the operation of the SSD to process a user read command in the embodiment; and

FIG. 6 is an example diagram of a list of types of errors that occur in the SSD (mainly, errors that occur due to a factor on the back-end side), factors and detection methods, and notification methods in the embodiment.

### DETAILED DESCRIPTION

In general, according to one embodiment, a memory control device comprises a first controller, a second controller, an access module, and a response sort module. The first controller is configured to control processing of a data access command to a nonvolatile memory from a host. The second controller is configured to control processing assigned to the second controller between the first controller and the second controller. The access module is configured to perform data access to the nonvolatile memory in response to a command from the first controller or the second controller. The response sort module is configured to, when an error occurs in the data access by the access module, return a response to the second controller instead of the first controller.

According to another embodiment, a memory device comprises a nonvolatile memory, a first controller, a second controller, an access module, and a response sort module. The first controller is configured to control processing of a data access command to the nonvolatile memory from a host. The second controller is configured to control processing assigned to the second controller between the first controller and the second controller. The access module is configured to perform data access to the nonvolatile memory in response to a command from the first controller or the second controller. The response sort module is configured to, when an error occurs in the data access by the access module, return a response to the second controller instead of the first controller.

According to still another embodiment, there is provided a memory control method comprising: controlling, by a first controller, processing of a data access command to a nonvolatile memory from a host; controlling, by a second controller, processing assigned to the second controller between the first controller and the second controller; performing, by an access module, data access to the nonvolatile memory in response to a command from the first controller or the second controller; and returning, by a response sort module, a response to the second controller instead of the first controller when an error has occurred in the data access by the access module.

Various embodiments will be described hereinafter with reference to the accompanying drawings.

In the following embodiments, the memory control device, the memory device, and the memory control method will be described as being applied to a solid state drive (SSD) provided with a system-on-a-chip (SoC) and connected to a computer such as a personal computer (PC) and/or server workstation (WS); which serves as a host device.

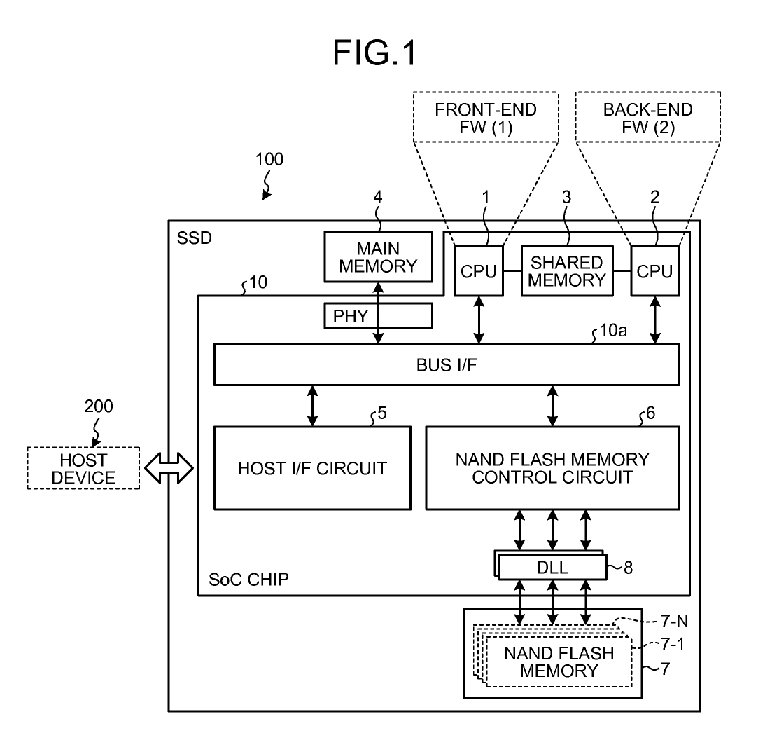

FIG. 1 is a block diagram of an SSD 100 according to an embodiment.

As illustrated in FIG. 1, the SSD (memory device) 100 functions as an external memory of a host device 200 such as PC and/or WS. The SSD 100 comprises a central processing unit (CPU) 1 as a first controller, a CPU 2 as a second controller, a shared memory 3, a main memory 4, a host interface (I/F) circuit 5, and a NAND flash memory control circuit 6, which are connected to one another via a bus I/F 10a to allow data communication among them. A SoC chip 10 (memory controller) comprises the constituent elements 1 to 6 except the main memory 4.

A group of NAND flash memories 7 is connected to the NAND flash memory control circuit 6 via Delay Locked Loop (DLL) 8 such that data is communicable between them.

The CPU 1 and 2 are controllers comprising a CPU cache memory such as a static random access memory (SRAM). In the embodiment, the CPU 1 is a front-end controller that mainly controls processing of data access commands to the NAND flash memories 7 from the host device 200. The data access commands include user write commands and user read commands. Meanwhile, the CPU 2 is a back-end controller that controls processing assigned thereto between the CPU 1 and 2.

The shared memory 3 is a storage used for communication between the CPU 1 and 2. The shared memory 3 may be, for example, a shared SRAM.

The main memory 4 functions as a buffer memory, a work memory, and a storage to store various back-end tables of management such as a mapping table between NAND flash memory's physical and logical addresses. The main memory 4 may be, for example, a dynamic random access memory (DRAM).

The host I/F circuit 5 is an I/F circuit controlling connection to the host device 200. The host I/F circuit 5 is herein referred to as SASC based on a serial attached small computer system interface (SAS) protocol.

The NAND flash memory control circuit 6 controls data access to the NAND flash memories 7 in response to a command from the CPU 1 or 2.

The NAND flash memories 7 includes a plurality of NAND flash memories 7-1 to 7-N (N can be an arbitrary integer).

Hereinafter, the NAND flash memories 7-1 to 7-N may each be simply denoted by “7” when not specifically identified. Each of the NAND flash memories 7-1 to 7-N is a storage such as a nonvolatile memory that stores data specified by the host device 200 and data managed in the main memory 4.

In the embodiment, a plurality of NAND flash memories are set as a group, i.e., one channel, and the SSD 100 has a plurality of channels such that data access can be performed concurrently in units of channels.

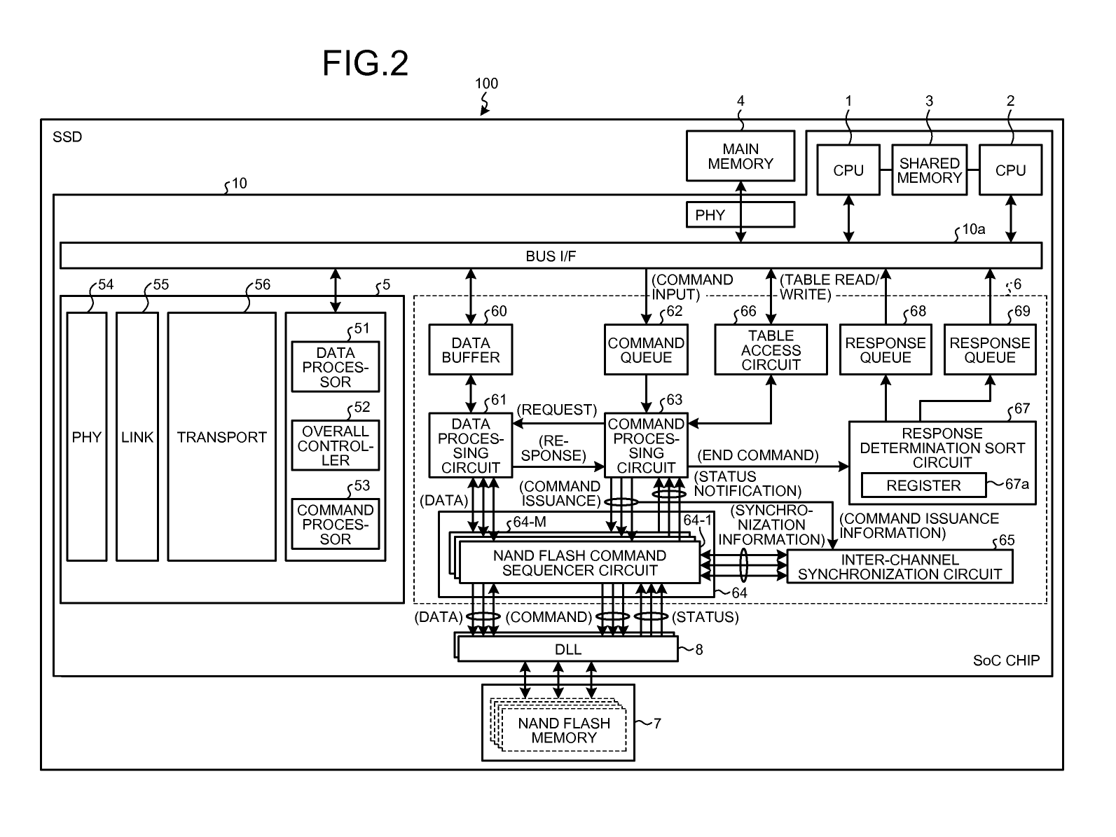

FIG. 2 is a detailed block diagram of the host I/F circuit 5 and the NAND flash memory control circuit 6 illustrated in FIG. 1.

As illustrated in FIG, 2, the host I/F circuit 5 comprises a data processor 51, an overall controller 52, a command processor 53, a physical layer (PHY) 54, a link 55, and a transport 56.

The NAND flash memory control circuit 6 comprises a data buffer 60, a data processing circuit 61, a command queue 62, a command processing circuit 63, a group of NAND flash command sequencer circuits 64, an inter-channel synchronization circuit 65, a table access circuit 66, a response determination sort circuit 67 (response sort module), and response queues 68 and 69.

The data buffer 60 is a storage for buffer data.

The data processing circuit 61 is a circuit to process data.

The command queue 62 is a circuit to queue commands, such as those from the CPU 1 and 2, and to write commands automatically issued by hardware for write operation after read operation for compaction.

The command processing circuit 63 determines an address in the NAND flash memory 7 as well as distributing/sorting into the channels.

The NAND flash command sequencer circuit 64 includes a plurality of NAND flash command sequencer circuit 64-1 to 64-M (M can be an arbitrary integer) each corresponding to one of the channels. Hereinafter, each of the NAND flash command sequencer circuits 64-1 to 64-M may be simply denoted by “64” when not specifically identified.

Each of the NAND flash command sequencer circuit 64-1 to 69-M issues a command to access to the NAND flash memory 7 of the corresponding channel, thereby performing data access (user read/write access) to the NAND flash memory 7. The issued command is queued in the NAND flash command sequencer circuit 64 with respect to each channel.

The inter-channel synchronization circuit 65 is a circuit to achieve synchronization between the channels and to make parity data of write operation and to calculate correct data using parity data when data error of read operation cannot be corrected by ECC.

The table access circuit 66 is a circuit to get and/or update the various tables which are located in the main memory 4.

The response determination sort circuit 67 determines whether to sort a response, which indicates the processing result of data access to the NAND flash memory 7, into the response queue 68 or 69 based on status result. According to the determination result, the response determination sort circuit 67 outputs (issues) the response to either one of the response queues 68 and 69.

More specifically, the response determination sort circuit 67 comprises a register (RplyTgt, which means Target destination of Reply) 67a that determines whether to send a response to the response queue 68 or 69. In the register 67a of the embodiment, it is set that a response is returned to the CPU that is the source of a command.

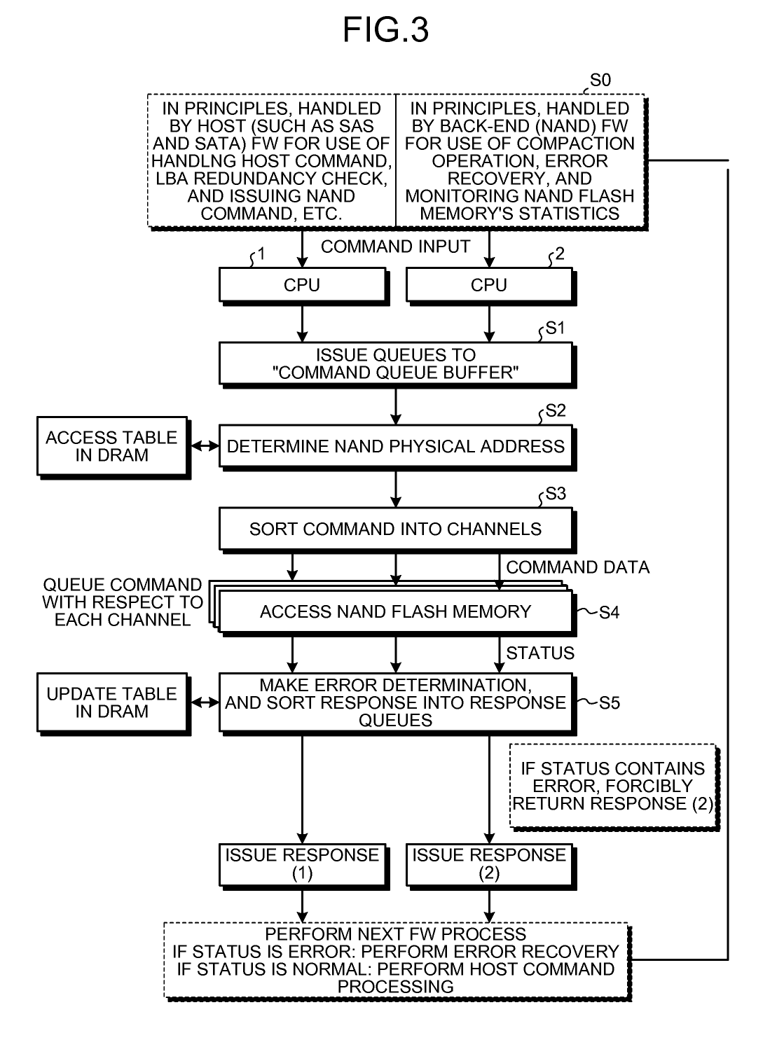

Further, having determined that no error has occurred, i.e., operation is normal, by status check, the response determination sort circuit 67 of the embodiment outputs a response (1) (of FIG. 3) indicating that a read/write command is properly completed to the response queue 68 according to the setting in the register 67a to return the response (1) (of FIG. 3) to the CPU 1 that is the source of a command.

On the other hand, having determined that an error has occurred by status check, the response determination sort circuit 67 outputs a response (2) (of FIG. 3) indicating the occurrence of the error to the response queue 69 regardless of the setting in the register 67a to return the response (2) (of FIG. 3) not to the CPU 1 that is the source of a command but to the CPU 2 for error recovery.

The response queues 68 and 69 are circuits to queue responses. In the embodiment, the response (1) to the CPU 1 is queued in the response queue 68, while the response (2) to the CPU 2 is queued in the response queue 69.

In the SSD 100 of the embodiment, the CPU 1 executes firmware FW (1) in charge of tasks including analysis of a command from the host device 200, logical block address (LBA) redundancy check, and input of a command to the NAND flash memory control circuit 6. The CPU 2 executes firmware FW (2) in charge of tasks including compaction, patrol, error recovery, and statistical information measurement.

That is, in the SSD 100 of the embodiment, tasks are divided or shared between the CPUs 1 and 2 to ensure the system performance when the SSD 100 operates normally.

When the system power of the SSD 100 of the embodiment is turned on, a boot program stored in a boot read only memory (ROM) (not illustrated) is loaded into the CPU cache memory (SRAM) of the CPUs 1 and 2 or the main memory 4 (DRAM), and thus the FW (1) and FW (2) are executed.

FIG. 3 is a flowchart of the operation of the SSD 100 configured as above. FIG. 3 illustrates, by way of example, processing of a user write command from the host device 200.

As illustrated in FIG. 3, first, the CPU 1 analyzes a command from the host device 200 (S0).

The CPU 1 sends the user write command for the NAND flash memory 7 to the NAND flash memory control circuit 6 (S1). In the NAND flash memory control circuit 6, the command is queued in the command queue 62, and queued commands are sequentially executed.

The user write command is executed when its turn comes. Then, the table access circuit 66 accesses a table stored in the main memory 4 to determine a NAND physical address, thereby determining which data is transferred to which channel (S2).

The command processing circuit 63 sorts the command into the channels (S3). Thus, write commands divided or sorted into the channels are queued in channel queues in the NAND flash command sequencer circuits 64 corresponding to the channels, respectively.

The NAND flash command sequencer circuits 64 each independently perform write operation to the NAND flash memories 7 (S4). In the case of user write operation, the inter-channel synchronization circuit 65 achieves synchronization between the channels as required.

After the NAND flash command sequencer circuits 64 complete the write operation to the NAND flash memories 7, the response determination sort circuit 67 makes an error determination, i.e., determines whether the write operation has been performed properly, based on status check (S5). In the status check, statuses are collected from the channels to the response determination sort circuit 67 via the command processing circuit 63, and are put together as response information.

Having determined that there is no error as a result of the error determination, the response determination sort circuit 67 outputs (issues) the response (1) indicating that the write command is properly completed to the response queue 68 according to the setting in the register 67a to return the response (1) to the CPU 1 that is the source of the command.

On the other hand, having determined that an error has occurred as a result of the error determination, the response determination sort circuit 67 outputs (issues) the response (2) indicating the occurrence of the error to the response queue 69 regardless of the setting in the register 67a to forcibly return the response (2) to the CPU 2.

In this case which some channels have error status, if an error does not occur in all the channels, to clear out the command queue 62 and the channel queues in the NAND flash command sequencer circuits 64, the NAND flash memory control circuit 6 sets the status of a channel where operation has been performed properly as error to disable the user write command and the following commands. The command treated as error in this manner is regarded as being purged to be distinguished from error and separately managed. This separate management is aimed at executing the command again with respect to each physical address corresponding to LBA. Incidentally, the managed information can be used for statistical information measurement.

After the process of S5, the next firmware process starts. More specifically, if an error has occurred, a response treated as error is collected to the CPU 2 at S0. Then, the process is shifted to the phase where errors are recovered collectively by the FW (2). After the error processing, the purged command is subjected to the same processing as the previous processing before purging.

More specifically, the NAND flash memory control circuit 6 executes the write command again as the error recovery. That is, data is transferred again from the main memory 4 to the NAND flash memory 7 (when at user write operation).

If the re-executed write command is properly completed, in the NAND flash memory control circuit 6, the response determination sort circuit 67 returns a response according to the setting in the register 67a to the CPU 1 that has issued the command first.

On the other hand, if an error occurs again in the re-executed write command, the NAND flash memory control circuit 6 performs again the error recovery as described above. That is, a response is collected to the CPU 2 to recover the error.

In the NAND flash memory control circuit 6 of the embodiment, the error recovery is set to be repeated up to the maximum number of times. Accordingly, the error recovery is performed for a long time, which solves the problem that the user seems to be locked.

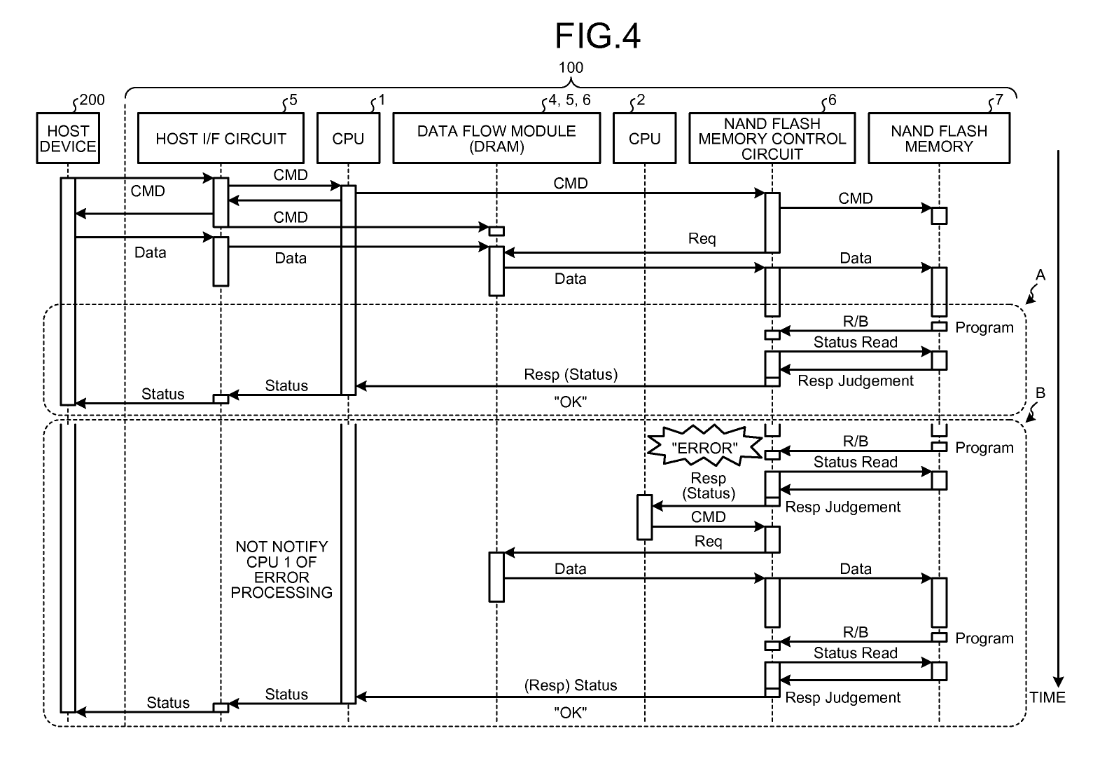

FIG. 4 is a sequence diagram of the operation of the SSD 100 to process a user write command.

In FIG. 4, a portion indicated by “A” illustrates the normal operation, while a portion indicated by “B” illustrates the operation upon occurrence of an error. In FIG. 4, attention is focused on one channel.

As illustrated in FIG. 4, first, a user write command (CMD) from the host device 200 is fed to the command processor 53 via the PHY 54, the link 55, and the transport 56 in the host I/F circuit 5 (SASC) and processed therein.

The host I/F circuit 5 then notifies the CPU 1, i.e., the FW (1), that the write command is received from the host device 200. The CPU 1 analyzes the command and inputs it to the NAND flash memory control circuit 6. In the NAND flash memory control circuit 6, the command is queued in the command queue 62. Besides, the host I/F circuit 5 receives data from the host device 200 and issues a command to a data flow module (for example, the data processing circuit 61 and the like) to store the received data in the main memory 4 (DRAM). In response to the command, the data flow module stores the data from the host device 200 in the main memory 4.

When ready to receive data, the NAND flash command sequencer circuit 64 outputs a request (Req) to start data transfer to the data flow module. Then, under the control of the data flow module, data transfer starts from the main memory 4 (DRAM) to the NAND flash command sequencer circuit 64 of the NAND flash memory control circuit 6.

After that, the NAND flash command sequencer circuit 64 transfers the received data to the NAND flash memory 7. Upon completion of ready/busy (R/B) by the program, the data write operation ends.

Thereafter, the NAND flash memory control circuit 6 issues a status read command to the NAND flash memory 7 to check the status of the command processing. If the status is normal, as indicated by “A”, the response determination sort circuit 67 of the NAND flash memory control circuit 6 returns a response (Resp) to the CPU 1, i.e., the FW (1), that is the source of the command. Then, the host device 200 is notified of the successful completion of the user write command according to the SAS protocol via the host I/F circuit 5.

On the other hand, if the status is error, as indicated by “B”, the response determination sort circuit 67 of the NAND flash memory control circuit 6 returns a response not to the CPU 1 that is the source of the command but to the CPU 2 for error recovery. With this, in place of the CPU 1, the CPU 2 executes the user write command again to recover the error. If the error is recovered by the error recovery of the CPU 2, the response determination sort circuit 67 of the NAND flash memory control circuit 6 returns a response to the CPU 1, i.e., the FW (1), that is the source of the command. If an error occurs again, a response is returned to the CPU 2. When the FW (2) determines that the error cannot be recovered by a predetermined number of times of error recovery, operation is performed regarding the product as coming to the end of its life by self-monitoring, analysis and reporting technology (S.M.A.R.T.). In the practice, apart from the end of life due to wearing out of the NAND flash memory, almost all errors can be corrected by error check and correction (ECC) and channel level parity recovery mechanism.

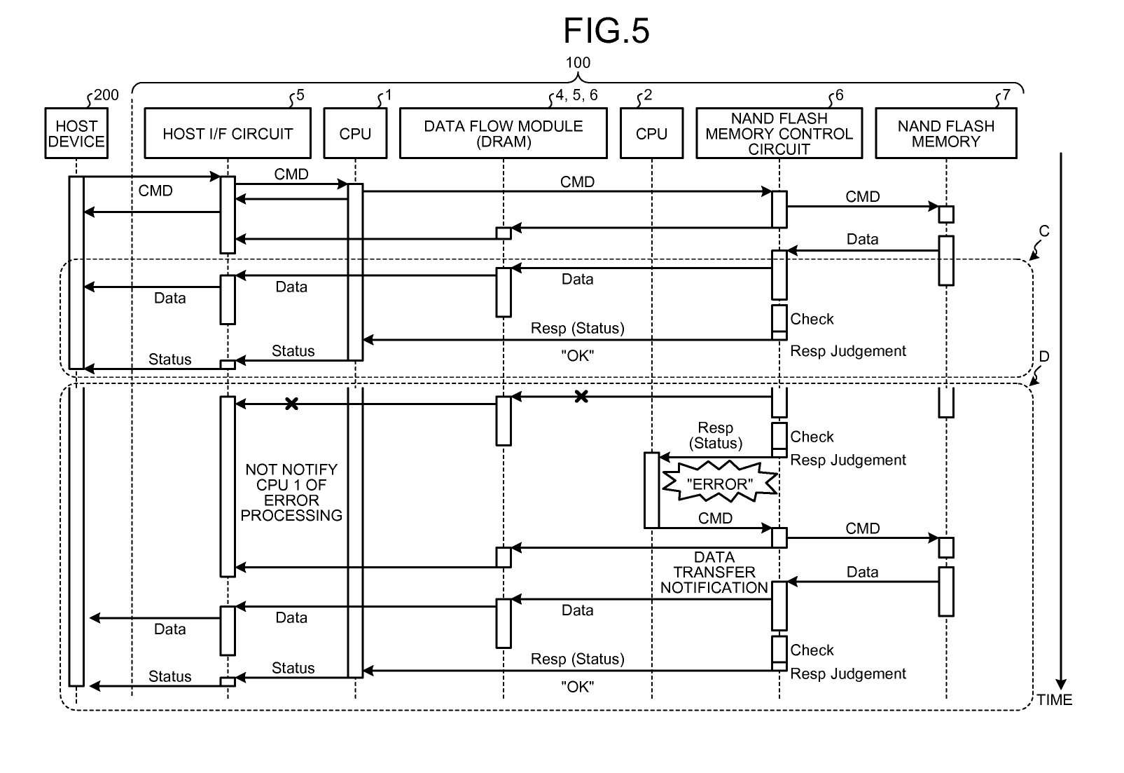

FIG. 5 is a sequence diagram of the operation of the SSD 100 to process a user read command.

In FIG. 5, similar to FIG. 4, a portion indicated by “C” illustrates the normal operation, while a portion indicated by “D” illustrates the operation upon occurrence of an error. In FIG. 5, attention is also focused on one channel as in FIG. 4.

As illustrated in FIG. 5, first, a user read command from the host device 200 is fed to the command processor 53 via the PHY 54, the link 55, and the transport 56 in the host I/F circuit 5 (SASC) and processed therein.

The host I/F circuit 5 then notifies the CPU 1, i.e., the FW (1), that the read command is received from the host device 200. The CPU 1 analyzes the command and inputs it to the NAND flash memory control circuit 6. In the NAND flash memory control circuit 6, the command is queued in the command queue 62.

When ready to transfer data, the NAND flash command sequencer circuit 64 receives data from the NAND flash memory 7, and transfers the received data to the data flow module.

The data flow module temporarily stores the received data in the main memory 4 (DRAM). The data temporarily stored in the main memory 4 (DRAM) is then transferred to the host device 200 via the host I/F circuit 5. The foregoing is the main flow of the normal operation.

The NAND flash memory control circuit 6 checks the status of the command processing. If the status is normal, as indicated by “C”, the response determination sort circuit 67 of the NAND flash memory control circuit 6 returns a response to the CPU 1, i.e., the FW (1), that is the source of the command, thereby notifying the CPU 1 that the data is read from the NAND flash memory 7 properly. Then, the host device 200 is notified that data communication is performed properly according to the SAS protocol with the read data.

On the other hand, if the status is error, as indicated by “D”, the response determination sort circuit 67 of the NAND flash memory control circuit 6 returns a response not to the CPU 1 that is the source of the command but to the CPU 2 for error recovery. With this, in place of the CPU 1, the CPU 2 executes the user read command again to recover the error. If the error is recovered by the error recovery of the CPU 2, the response determination sort circuit 67 of the NAND flash memory control circuit 6 returns a response to the CPU 1, i.e., the FW (1), that is the source of the command. If an error occurs again, a response is returned to the CPU 2. When the FW (2) determines that the error cannot be recovered by a predetermined number of times of error recovery, operation is performed regarding the product as coming to the end of its life by S.M.A.R.T. In the practice, apart from the end of life due to wearing out of the NAND flash memory, almost all errors can be corrected by error check and correction (ECC) and channel level parity recovery mechanism.

Incidentally, in FIG. 5 illustrating a sequence of the read operation of the SSD 100, except that data and control signals in the process flow opposite to the direction of those in the write operation illustrated in FIG. 4, the normal operation indicated by “C”, the operation upon occurrence of an error indicated by “D”, and the error recovery are performed in the same manner as in the write operation. Thus, the description will not be repeated.

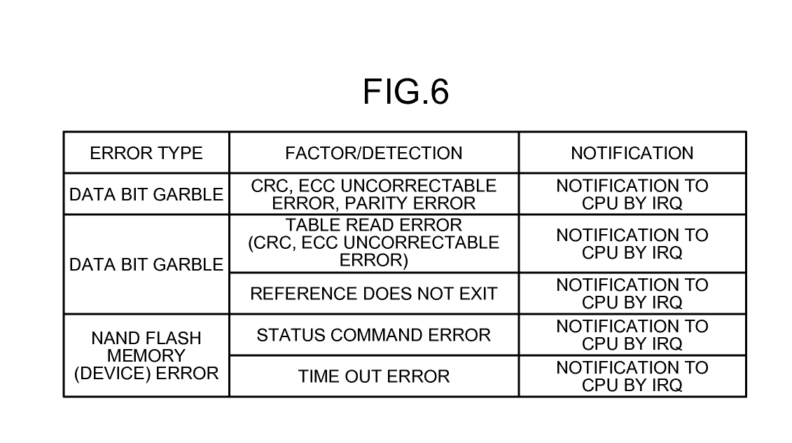

FIG. 6 is a diagram of a list of types of errors that occur in the SSD 100 (mainly, errors that occur due to a factor on the back-end side), factors and detection methods, and notification methods.

FIGS. 4 and 5 illustrate the cases of status error after write operation to the NAND flash memory 7 (FIG. 4) and error caused by garbled bits of data read from the NAND flash memory 7 (FIG. 5). Actually, as illustrated in FIG. 6, there are other errors such as garbled data due to a cosmic ray in memory devices such as SRAM in the circuits of the SSD 100. The embodiment is also applicable to such garbled data.

As described above, according to the embodiment, the FW (1) of the CPU 1, which is the source of a command, is not notified of the occurrence of an error. This eliminates communication between a plurality of CPUs upon occurrence of an error. Thus, error recovery requires less time.

While, in the above embodiment, the SoC chip 10 of the SSD 100 is described as having the two CPU 1 and 2, the SoC chip 10 may comprise three or more CPUs. That is, there may be provided a plurality of CPUs that control processing of a data access command to the NAND flash memory 7 from the host device 200 as with the CPU 1. Similarly, there may be provided a plurality of CPUs that control processing assigned thereto between the CPU 1 and the CPUs (compaction, statistical information measurement, etc.) as with the CPU 2. Further, there may be provided a plurality of both the CPUs.

If three or more CPUs are provided, preferably, one of them is set as a CPU for error recovery, i.e., a CPU to which the response determination sort circuit 67 returns a response as an error notification.

While the memory control device of the embodiment is described as the SoC chip 10 that controls the NAND flash memory and the memory device of the embodiment is described as the SSD 100 comprising the SoC chip 10, they are not so limited. For example, the memory control device of the embodiment may control a nonvolatile memory medium other than the NAND flash memory, and the memory device of the embodiment may comprise the other memory medium.

Still further, the circuitry and operation of the SSD and the NAND flash memory are described above by way of example only and not limitation.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory control device comprising:
a first controller configured to control processing of a data access command from a host, wherein the data access command comprises a request to access a nonvolatile memory;
a second controller;
an access module configured to access the nonvolatile memory in response to a command from the first controller or the second controller; and
a response sort module configured to return an error status response to the second controller in response to an error associated with the access module accessing the nonvolatile memory, wherein the response sort module does not return the error status response to the first controller.

2. A memory device comprising:
a nonvolatile memory;
a first controller configured to control processing of a data access command from a host, wherein the data access command comprises a request to access the nonvolatile memory;
a second controller;
an access module configured to access the nonvolatile memory in response to a command from the first controller or the second controller; and
a response sort module configured to return an error status response to the second controller in response to an error associated with the access module accessing the nonvolatile memory, wherein the response sort module does not return the error status response to the first controller.

3. The memory device of claim 2, wherein the second controller is further configured to perform error recovery in response to receiving the error status response from the response sort module, wherein the error recovery comprises re-executing the command.

4. The memory device of claim 3, wherein the response sort module is further configured to:
return a success response to the first controller in response to successful completion of the error recovery, and
return a second error status response to the second controller in response to a second error, wherein the second error is associated with the error recovery.

5. The memory device of claim 3, wherein the second controller is further configured to perform the error recovery up to a predetermined maximum number of times.

6. The memory device of claim 2, further comprising three or more controllers, including the first controller and the second controller, wherein the response sort module is further configured to return the error status response to the second controller in response to the error, and wherein the response sort module does not return the error status response to the remaining controllers of the three or more controllers.

7. A method for controlling a memory device, comprising:
processing, by a first controller, a data access command from a host, wherein the data access command comprises a request to access a nonvolatile memory;
accessing, by an access module, the nonvolatile memory in response to a command from the first controller or a second controller; and
returning, by a response sort module, an error status response to the second controller in response to an error associated with the access module accessing the nonvolatile memory, wherein the response sort module does not return the error status response to the first controller.
